(19) United States
(12) Patent Application Publication
(10) Pub. No.: US 2024/0418021 A1
(43) Pub. Date: Dec. 19, 2024

(54) Self-Aligning Pin

(71) Applicant: Ben Mahalko, Brookfield, WI (US)

(72) Inventor: Ben Mahalko, Brookfield, WI (US)

(21) Appl. No.: 18/818,978

(22) Filed: Aug. 29, 2024

Related U.S. Application Data
(63) Continuation of application No. 17/941,516, filed on Sep. 9, 2022.

(51) Int. Cl. E05D 5/12; E05D 3/02; E05D 5/10

(52) U.S. Cl. CPC E05D 5/121; E05D 3/02; E05D 2005/102; E05D 2005/122

(57) ABSTRACT

A self-aligning pin. The pin has a shaft and a curved end section with the diameter of the shaft and the curved end section being equal to one another.

### CROSS-REFERENCE TO RELATED APPLICATIONS

This application is a continuation of co-pending application Ser. No. 17/941,516 filed 9 Sep. 2022.

### BACKGROUND OF THE INVENTION

The present invention is directed towards pins that are inserted into a hinge, conduit, or mating receptacle.

Pins and related hinges, are designed so that the pin and the hinge mate with one another in a tight fashion. That is, there is essentially no space or gap between the pin and the hinge when the pin is inserted into the hinge so that the hinge and pin will be properly aligned. This also insures that there is no excessive moving or shifting for the pin within the hinge that could lead to breaking or snapping of the pin.

However, the tight arrangement between a pin and a hinge often makes it hard to properly insert the pin into the hinge. The pin may not align with the hinge, which often requires excessive force for the pin to be forced into the hinge. Often times a hammer is used to insert the pin. For large machinery, such as farm equipment, long or heavy pins may be used to join large hinges. This may require extensive force, such as using a sledge hammer to pound the pin into the hinge. This can be a cumbersome and time consuming endeavor.

### SUMMARY OF THE INVENTION

The present invention is directed to a self-aligning pin. The pin has a shaft that further has a spherically shaped end, which assists the pin in being properly aligned when being inserted into a hinge or similar receptacle for the pin. More particularly, the present invention provides a spherically shaped end having a diameter having the same width as the shaft.

The present invention further is directed towards a self-aligning pin that has a spherically shaped end separated from the main shaft of the pin.

Another aspect of the present invention is that the self-aligning pin may have a shaft that is of various polygonal shapes or is cylindrical.

In yet another aspect of the present invention, the shape of the self-aligning pin may be threaded.

### BRIEF DESCRIPTION OF DRAWINGS

FIG. 1 is a planar view of a pin and hinge according to the prior art.

FIG. 2 is a planar view of a pin being inserted into a hinge according to the prior art.

FIG. 3 is a planar view of a pin according to the present invention.

FIG. 3A is a perspective view of the pin shown in FIG. 3.

FIGS. 4A-4D demonstrate the pin of FIG. 3 being inserted into a hinge.

FIGS. 5A-D are perspective views of alternate embodiments of pins according to the present invention.

FIGS. 6-8 demonstrate various embodiments of the present invention positioned within a hinge.

FIG. 9 is a perspective view of a threaded pin according to the present invention.

FIGS. 9A-9B depict the threaded pin of FIG. 9 being inserted into a bolt.

FIGS. 10A-B depict alternate embodiments of a threaded pin according to the present invention.

FIG. 11A is a front perspective view of a square pin according to the present invention.

FIGS. 11B-E depict the pin of FIG. 11A being inserted into a square receptacle.

FIGS. 12A-C depict an alternate embodiment of a pin according to the present invention.

FIGS. 13A and 13B demonstrate the present invention being utilized within a power take off (PTO) shaft.

### DETAILED DESCRIPTION OF THE INVENTION

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

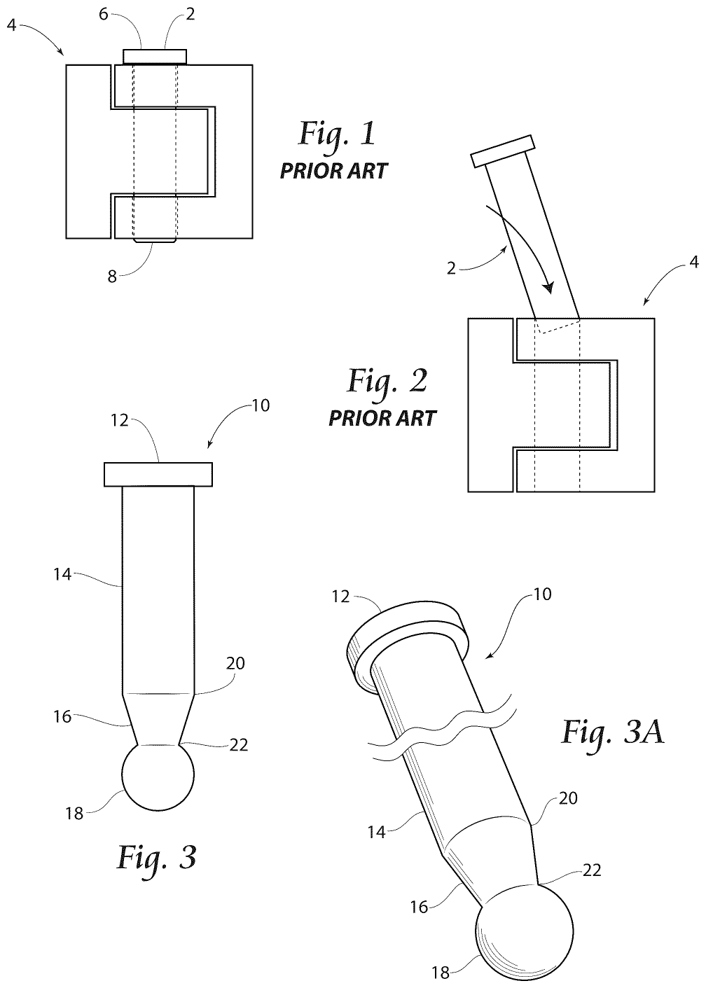

FIG. 1 is a planar view of a prior art pin 2 and hinge 4, with the pin 2 being inserted into the hinge 4. The typical arrangement for the pin 2 and the hinge 4 is for a tightly mating arrangement. The pin 2 has a standard flanged end 6 and flat end 8, with the flat end 8 being inserted into the hinge until the flanged end 6 abuts the hinge 4.

FIG. 2 demonstrates the pin 2 being inserted into the hinge 4. As is often the case, the pin 2 may not be completely aligned with the hinge 4, which makes it difficult to insert the pin 2 into the hinge 4. Even in situations where the pin 2 is inserted at a nearly aligned angle, e.g. an angle where the pin 2 and the hinge are only slightly cocked with one another, it may be difficult to insert the pin 2 into the hinge 4. Proper insertion of the pin 2 is cumbersome.

FIGS. 3 and 3A show a pin 10 according to the present invention. The pin 10 generally comprises a first flanged end 12, a shaft 14, a transfer section 16, and a curved end 18. The curved end 18 is preferably spherically shaped. The transfer section 16 tapers inwardly from the shaft 14 to the curved end 18. The transfer section has a first end 20 having a diameter the same as that of the shaft 14 and a second end 22 having a diameter less than that of the shaft.

As shown in FIG. 3A, the shaft 14 is cylindrically shaped. The spherically shaped curved end 18 has a diameter the same as that of the shaft 14, which assists in the insertion of the pin 10 into a hinge 4.

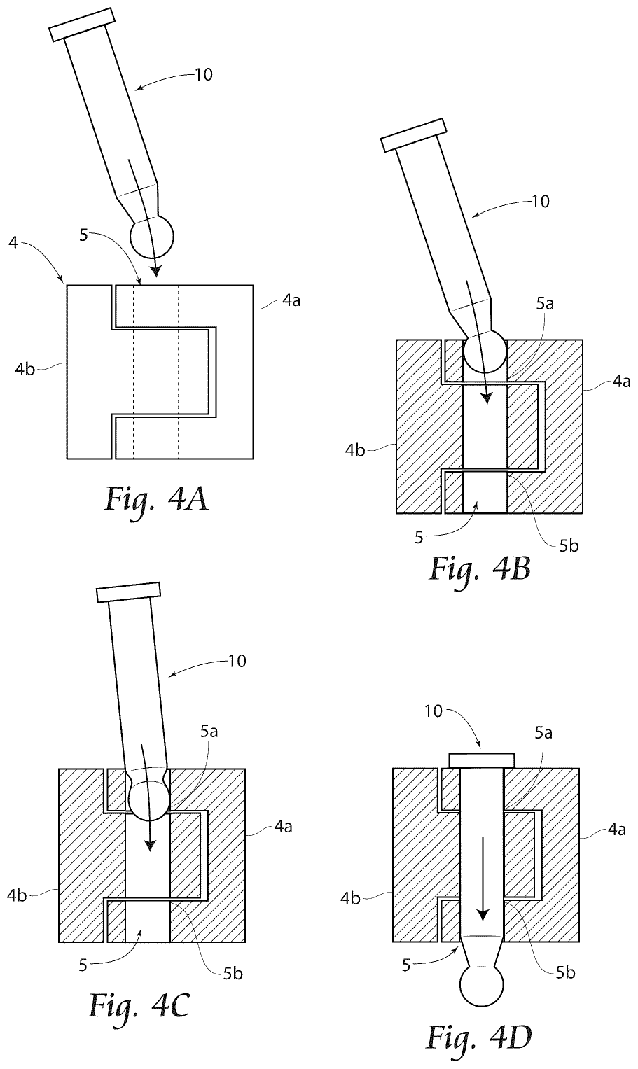

FIGS. 4A-4B demonstrate the pin 10 being inserted into the hinge 4. The hinge 4 is a typical hinge as previously shown, having a first section 4a and a second section 4b that are arranged in mating fashion with one another. The sections 4a and 4b form a conduit 5 that will receive the pin 10 (FIG. 4A). The pin 10 may be cocked (FIG. 4B) as with prior art pins, but the curved end 18 allows for the pin 10 to right itself (FIG. 4C) and to be axially aligned with the conduit. The pin can then be properly inserted into the conduit 5. Because the curved end 18 is the same diameter as that of the shaft 14, the pin 10 will slide easily through the conduit 5 as it passes junctions formed by the sections 4a and 4b, e.g. junctions 5a and 5b, to allow proper and efficient insertion of the pin 10.

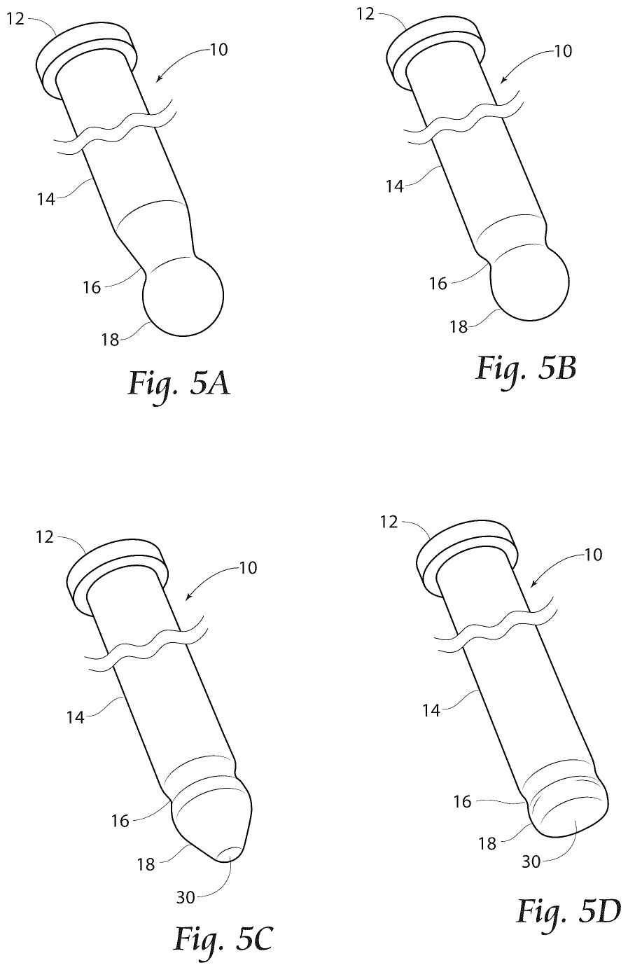

It should be understood that the pin 10 of the present invention can be arranged in various lengths and shapes and still fall within the scope of the present invention. Such examples are shown in FIGS. 5A-5B. For example the transfer section 15 is shown to have a tapered surface, with the surface uniformly tapering from the shaft 12 to the curved end 18. The length of the transfer section 16 can be of different lengths (see FIG. 5A compared to FIG. 5B or 5D.)

Furthermore, while the curved end 18 is shown to be spherical in FIGS. 5A and 5B, the spherical end 18 has a blunted tip 30 in each of FIGS. 5C and 5D. However, in each arrangement, the diameter of the spherical end 18 is the same diameter as that of the shaft 14.

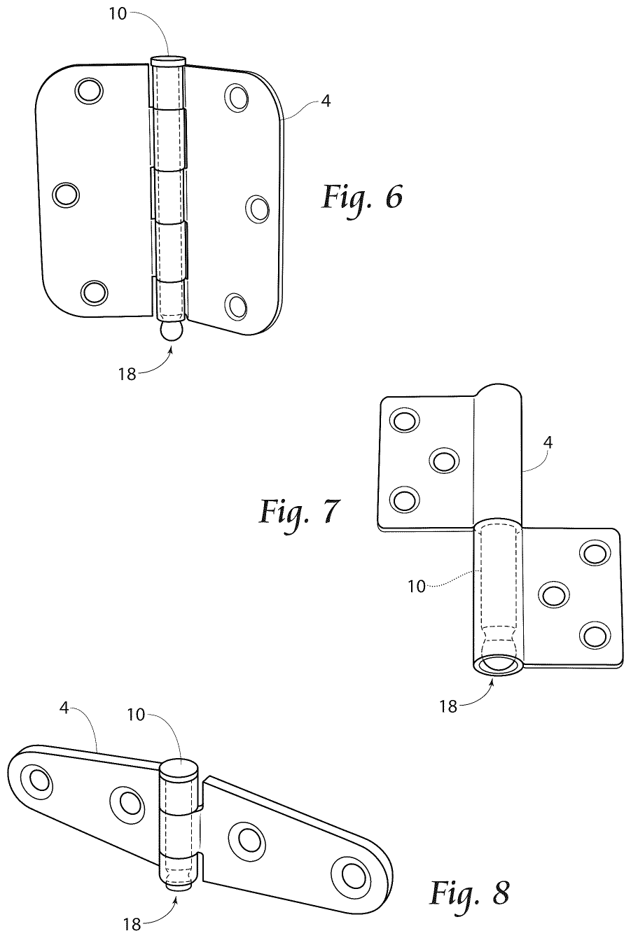

FIGS. 6-8 depict the pin 10 of the present invention being inserted into various hinges 14. The spherical end 18 may extend past the hinge 4 (FIG. 6), sit completely within the hinge 4 (FIG. 7), or extend partially past the hinge 4 (FIG. 8) when inserted. As such, it is also understood that the length of the shaft 14 of the pin may be altered as necessary for the hinge 4 and use as needed.

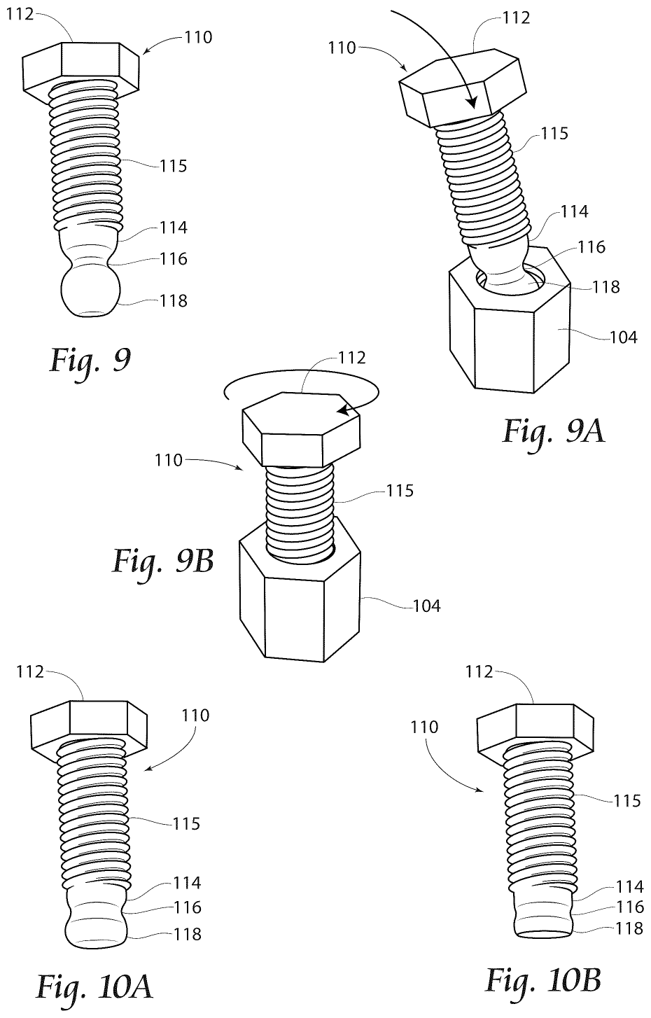

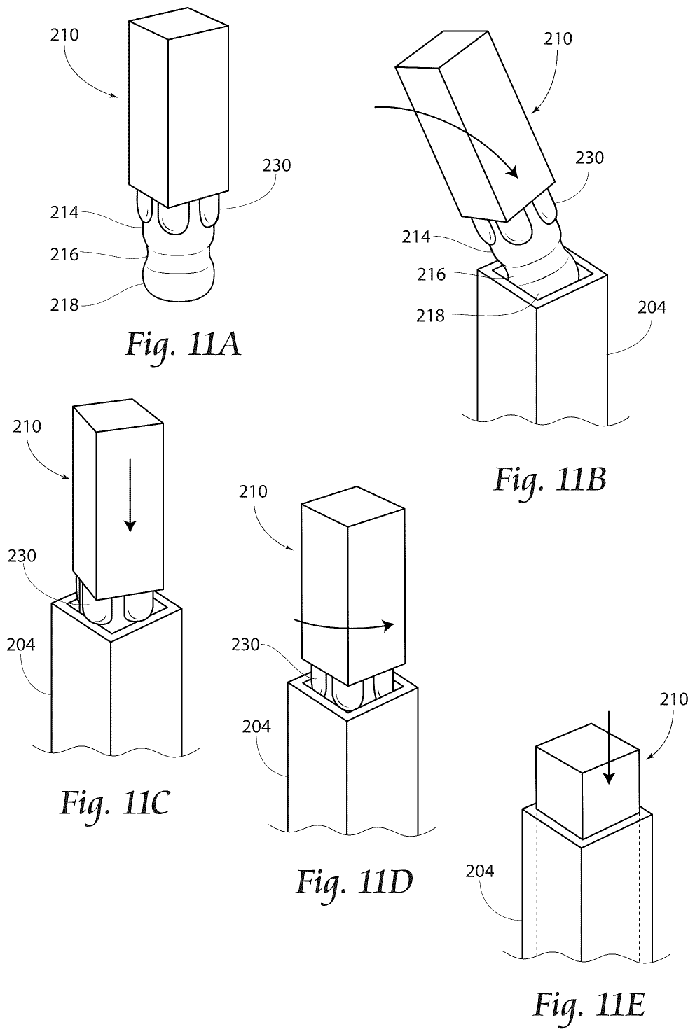

The present invention may also comprise embodiments having varying shapes and arrangements for the shaft of the present invention. For example, FIG. 9-10B contemplate a threaded pin 110, which can also can be considered a bolt. As with the pin 10, the pin 110 generally comprises a flanged end 112, a shaft 114, a transfer section 116, and a curved end 118, with the curved end 118 being designed as was the curved end 18 (see FIG. 10B and FIG. 5D, for example). The curved end 118 will have a diameter the same as the shaft 114.

The shaft 114 has an external threaded surface 114, which will mate with a threaded surface 105 located on a nut 104 (See FIGS. 9A and 9B). The nut 104 receives the threaded pin 110 in the same fashion as the hinge 4 received the pin 10, as previously noted. It is often the case that a bolt (i.e. threaded pin 110) can be cocked when being threaded onto the nut 104. The user may even make several rotations without realizing that the bolt is cocked, requiring the user to unscrew the bolt and attempt to realign the bolt within the nut. The threaded pin 110 aligns itself in the same fashion as the pin 10, with the pin 110 and the conduit inside of the bolt being in a parallel arrangement with one another. The pin 110 can then be easily and correctly threaded onto the nut 104 (FIGS. 9A and 9B). It should be understood that the diameter of the curved section 118 is equal to that of shaft 114, not including the threaded section 115, so the curved section 118 does not interfere with the insertion process into the nut 104.

The present invention is also contemplated for pins that are not cylindrical but may have another polygonal shape. For example, FIGS. 11A-11E demonstrate a pin 210 having a shaft 214, a transfer section 216, and a curved section 218, similar to the other pins 10, 110 described. The shaft 214 further has a square external arrangement, which would have an area that is the same as a receptacle 204 (FIG. 11B) that the pin 210 would mate with, in a similar fashion as previously described. The curved section 218 also has a diameter the same as that of the shaft 214.

The shaft 214 also has curved protuberances locate on its surface. The protuberances will assist in aligning the pin 210 with the receptacle 204. As shown in FIG. 11B, the pin 210 is inserted into the receptacle 204, with the potential for the pin 210 to be cocked. The curved section 218 assists in aligning the axis of the pin 210 with the axis of the receptacle 204. However, the square portion of the pin 210 may not be aligned with the receptacle (FIG. 11C). The secondary protuberances act in a similar fashion as the curved section 218, to allow the pin 210 to be rotated in place (FIG. 11D) so that the pin 210 can be further inserted into the receptacle (FIG. 11E).

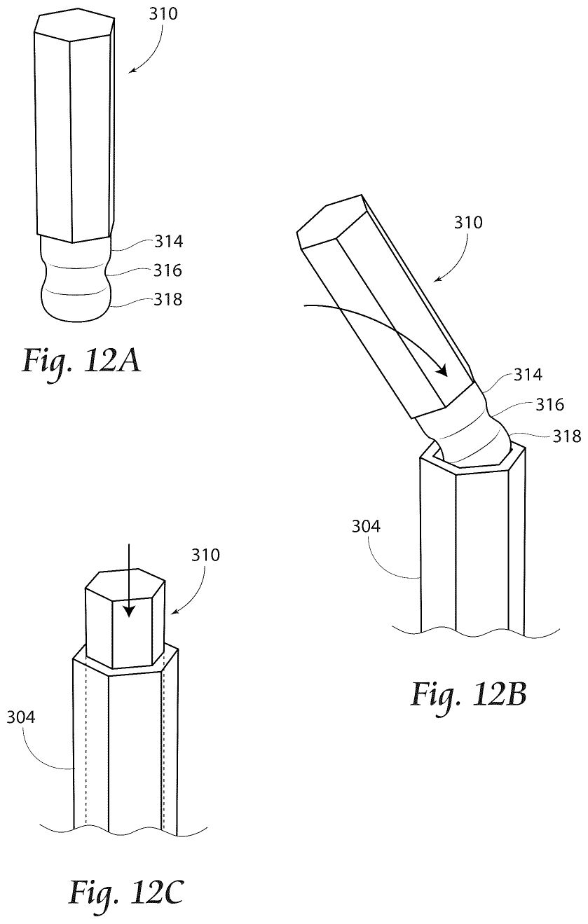

FIGS. 12A-12C also demonstrate that the present invention can be used for further polygonal shapes. A pin 310 comprises a shaft 314, a transfer section 316, and a curved end section 318. An outer surface of the shaft 314 has a hexagonal shape. The curved end section 318 has the same diameter as the shaft, with the shaft 314 essentially is preferably the incircle of the hexagon. That is the shaft diameter is preferably the largest circle that would fit within the hexagonal portion of the shaft 314. This allows insertion of the pin 310 into a receptacle 304, even when the pin 310 is cocked (FIG. 12B), as the arrangement of the curved end section 318 and the shaft 314 having the same diameter allows for the pin 310 to self-align and be inserted (FIG. 12C).

The various features of the present invention could be incorporated into the different embodiments, as necessary. For example, the flanged ends 12 (FIG. 3) and 112 (FIG. 9) could be incorporated into the embodiments shown in FIGS. 11A and 12E, and would be understood to fall within the scope of the invention.

Likewise, it is contemplated that more than one curved section may be incorporated into a pin according to the present invention. For example, it may be desirous, particularly for a longer pin, that two or more curves sections may be incorporated so that the pin may more easily navigate a hinge with multiple joints.

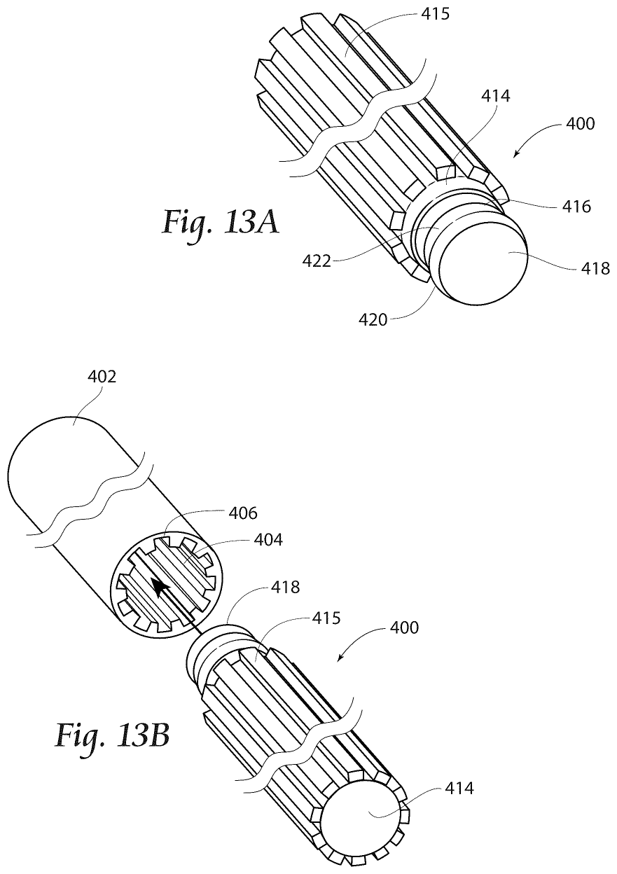

The utility of the present invention is further exemplified in FIGS. 13A and 13C which incorporates the present invention into a power take off (PTO) shaft 400. The PTO 400 is a typical shaft attached or integrated with a tractor or other heavy duty equipment to transmit power from an engine to an attached device. The PTO shaft 400 comprises a central shaft 414 having a plurality of splines 415 extending outwardly from the central shaft 414. The PTO shaft 400 also has a curved section 418 having a diameter that is the same as that of the central shaft, consistent with the other embodiments of the present invention. Similarly, the PTO shaft 400 has a transfer section 416 that tapers inwardly from the central shaft 414 to the curved end 418. The transfer section 416 has a first end 420 having a diameter the same as that of the central shaft 414 and a second end 422 having a diameter less than that of the central shaft 414.

The PTO shaft 400 will mate with a machinery shaft 402, which has a central conduit 404 with a plurality of extensions 406 that mate with the spines 416 on the PTO shaft 400. The machinery shaft 402 will be brought near the PTO shaft 400, with the extensions 406 aligned with spines 415. As with the other embodiments, the curved end 418 helps axial alignment of the PTO shaft 400 and the machinery shaft 402.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1. A pin for insertion into a threaded conduit having a central axis, said pin comprising:
a shaft having a length extending from a first end to a second end, said shaft having a constant diameter along the length and a central axis;
a flanged end connected to said first end;
a helical thread located on and surrounding said shaft, said helical thread forming a constant length between each of said subsequent rings of said thread;
a transfer section connected to the shaft at the second end, said diameter of said transfer shaft equal to the diameter of said shaft where said transfer section is connected to said shaft;
a curved end section connected to the transfer section and axially aligned with the shaft and the transfer section, said curved section having a continuous curved surface resulting in a central section having an outer diameter that is the same diameter as the shaft, said central section having a length less than the constant length of said helical thread;
wherein said curved end section allows said pin to be axially self-aligned with said conduit by aligning said shaft axis and conduit axis without creating any angular momentum;
wherein said transfer section has a tapered surface extending from said shaft to said curved end section, said surface tapered from said shaft to said curved section, said transfer section having a gradual reduction in diameter from said constant diameter where said transfer section connects to said shaft, said gradual reduction in diameter resulting in an intermediate diameter less than of said curved section and of said shaft.

2. The pin according to claim 1, wherein said shaft is cylindrical.

3. The pin according to claim 1, wherein said flanged end has a hexagonal shape.

4. The pin according to claim 1, wherein said flanged end has a square shape.

5. The pin according to claim 1, wherein said flanged end has a round shape.

6. The pin according to claim 1, wherein the pin comprises a second curved section.

7. A threaded pin for insertion into a threaded conduit having an axis, said threaded pin comprising:
a shaft having a continuous length extending from a first end to a second end, said shaft having a constant diameter along the length and a central axis;
a flanged end connected to said first end;
a helical thread located on and surrounding said shaft;
a transfer section connected to the shaft at the second end, said diameter of said transfer shaft equal to the diameter of said shaft where said transfer section is connected to said shaft;
a curved end section connected to the transfer section and axially aligned with the shaft and the transfer section, said curved section having a continuous curved surface resulting in a central section having an outer diameter that is the same diameter as the shaft, said curved section continuing said continuous curve past said central section in said same direction,
wherein said curved end section allows said pin to be axially self-aligned with said conduit by aligning said shaft axis and conduit axis without creating any angular momentum;
wherein said transfer section has a tapered surface extending from said shaft to said curved end section, said surface tapered from said shaft to said curved section, said transfer section having a gradual reduction in diameter from said constant diameter where said transfer section connects to said shaft, said gradual reduction in diameter resulting in an intermediate diameter less than of said curved section and of said shaft.

8. The pin according to claim 7, wherein said shaft is cylindrical.

9. The pin according to claim 7, wherein said flanged end has a hexagonal shape.

10. The pin according to claim 7, wherein said flanged end has a square shape.

11. The pin according to claim 7, wherein said flanged end has a round shape.

12. The pin according to claim 7, wherein the pin comprises a second curved section.

13. The pin according to claim 7, wherein said helical thread is continuous.

14. A method for inserting a pin into a threaded conduit comprising the steps of:
providing a pin according to claim 1;
initially inserting said pin into said threaded conduit;
continuing to insert said pin so that said curved section engages with said conduit; and
rotating said pin while maintaining engagement with said curved section and said conduit until said pin aligns with said conduit.
